(19) United States
(12) Patent Application Publication
(10) Pub. No.: US 2019/0027776 A1
(43) Pub. Date: Jan. 24, 2019

(54) BATTERY MODULE

(71) Applicant: Panasonic Intellectual Property Management Co., Ltd., Osaka (JP)

(72) Inventors: Yuta Kuroda, Osaka (JP); Masanobu Takeuchi, Osaka (JP)

(73) Assignee: Panasonic Intellectual Property Management Co., Ltd., Osaka (JP)

(21) Appl. No.: 16/141,081

(22) Filed: Sep. 25, 2018

Related U.S. Application Data
(63) Continuation of application No. PCT/JP2017/001306, filed on Jan. 17, 2017.

(30) Foreign Application Priority Data
Mar. 31, 2016 (JP) 2016-072181

(51) Int. Cl. H01M 10/04; H02J 7/00; H01M 2/10

(52) U.S. Cl. CPC H01M 10/045; H01M 2/1016; H02J 7/0013; H02J 7/0078

(57) ABSTRACT

A battery module includes multiple cells that are connected in parallel to each other and a positive-side lead plate electrically connected to a positive electrode of each cell. The battery module further includes a potential difference detection unit that detects three potential differences between two points of three points on the positive-side lead plate and a microcomputer that determines an abnormality of one cell based on a signal indicating the three potential differences between two points from the potential difference detection unit.

### TECHNICAL FIELD

The present disclosure relates to a battery module.

### BACKGROUND ART

Battery modules in related art in which multiple cells are connected in parallel to each other are disclosed in, for example, PTL 1. This battery module disclosed in PTL 1 has a configuration in which an electrical circuit including a pull-up resistor and a pull-down resistor is electrically connected to each cell, an abnormality is determined based on the deterioration state of the cell by a microcomputer, and the circuit is switched through pull-up control and pull-down control. Since the pull-up control is performed using predetermined voltage if no abnormality is detected in the cell, no current flows through the pull-down resistor. In contrast, if an abnormality is detected, the pull-down control is performed to cause current to flow through the pull-down resistor. In this battery module, the number of abnormal cells is calculated based on the voltage of a signal line, which is varied upon the flowing of the current through the pull-down resister.

### CITATION LIST

### Patent Literature

PTL 1: Japanese Published Unexamined Patent Application No. 2010-19791

### SUMMARY OF INVENTION

With the battery module in PTL 1, only a cell that is electrochemically disabled is capable of being detected and an abnormality that occurs before the deterioration of the cell advances and the cell is in an electrochemically inactive state is not capable of being detected. In addition, since it is necessary to provide the electrical circuit for each cell, the battery module is increased in size.

It is an object of the present disclosure to provide a battery module that is capable of detecting any cell that becomes abnormal in an electrochemically active state and that is capable of easily reducing the size.

A battery module according to the present disclosure includes multiple cells that are connected in parallel to each other and a one-side lead plate electrically connected to a one-side electrode of each cell. The battery module further includes a potential difference detection unit that detects one or more potential differences between two points on the one-side lead plate and an abnormality determination unit that determines an abnormality of one or more cells based on the one or more potential differences between two points from the potential difference detection unit.

According to the battery module according to the present disclosure, it is possible to detect any cell that becomes abnormal in the electrochemically active state and to easily reduce the size of the battery module.

### BRIEF DESCRIPTION OF DRAWINGS

FIG. 1 is a diagram schematically illustrating the configuration of a battery module according to an embodiment of the present disclosure.

FIG. 2 is a diagram illustrating the positional relationship between three points the potential differences between which are detected on a positive-side lead plate.

FIG. 3 is an exploded perspective view of a module main body.

FIG. 4 is a diagram for describing the principle and method of identifying an abnormal cell in the battery module and calculating a supplied or received current value of current which the abnormal cell supplies to the positive-side lead plate or which the abnormal cell receives from the positive-side lead plate by a microcomputer.

FIG. 5 is a diagram illustrating current flowing through the positive-side lead plate, which forms a two-dimensional plane, using two-dimensional vectors.

FIG. 6 is a flowchart illustrating an exemplary process of determining an abnormality of the battery module, which is performed by the microcomputer.

FIG. 7 is a diagram of a modification corresponding to FIG. 2.

### DESCRIPTION OF EMBODIMENTS

Embodiments according to the present disclosure will herein be described in detail with reference to the attached drawings. It is originally supposed that, when multiple embodiments or modifications are included in the following description, the characteristic portions of the embodiments or modifications may be appropriately combined to build new embodiments.

In a battery module including multiple cells that are connected in parallel to each other, if minute short-circuit occurs in a certain cell and the resistance of the cell is abnormally decreased, the cell performs charge and discharge using high current, compared with those in the other cells, during charging and discharging to cause lithium (Li) precipitation, thereby making the battery module unstable. In contrast, if any cell the resistance of which is abnormally increased exists, the voltage of only the cell is increased or decreased, compared with those of the other cells, in an open circuit state after the charging or after the discharging and the cell is undesirably charged with high current from the other cells or undesirably discharge high current to the other cells.

In a battery module of the present disclosure, unlike the battery module in PTL 1, the main body of the module including multiple cells that are connected in parallel to each other is monitored, instead of monitoring of an abnormality of each cell, to enable any abnormal cell to be detected before the cell is in an electrochemically inactive state. The configuration of the battery module capable of performing such detection will be described below.

A case is described below in which one-side electrode is a positive electrode and a lead plate that causes a potential difference detection unit to detect the difference between cells is a positive-side lead plate. However, the one-side electrode may be a negative electrode and the lead plate that causes the potential difference detection unit to detect the difference between cells may be a negative-side lead plate.

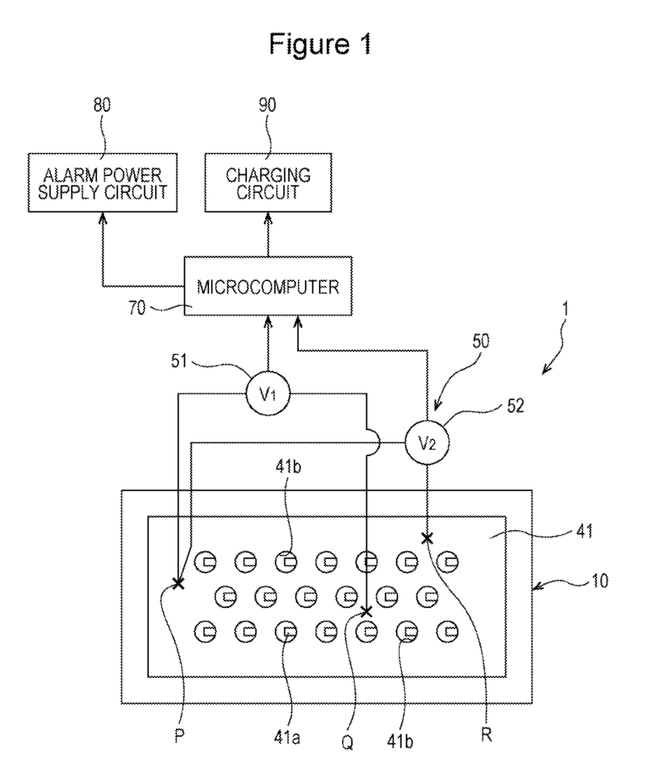

FIG. 1 is a diagram schematically illustrating the configuration of a battery module 1 according to an embodiment of the present disclosure. As illustrated in FIG. 1, this battery module 1 includes a module main body 10, a potential difference detection unit 50, a microcomputer 70, which is an example of an abnormality determination unit, an alarm power supply circuit 80, and a charging circuit 90.

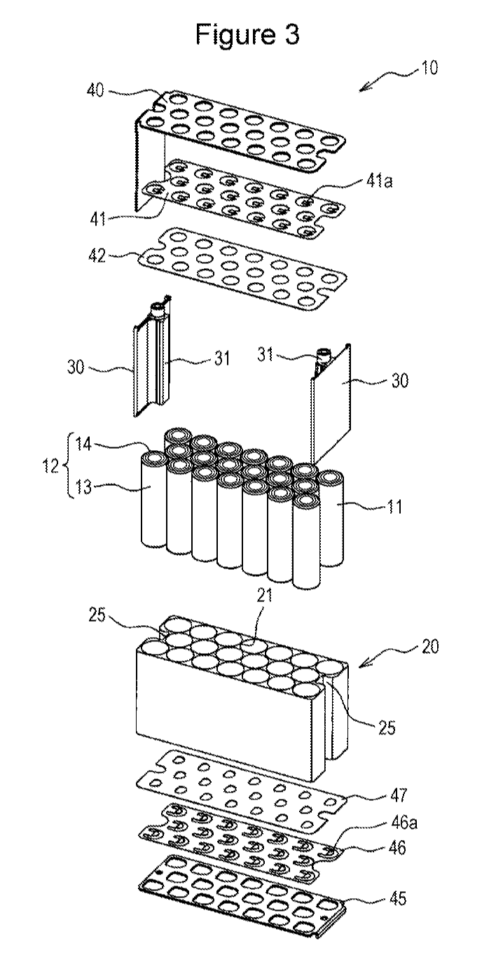

The module main body 10 includes multiple cells that are connected in parallel to each other (not illustrated in FIG. 1) and a positive-side lead plate 41 serving as one-side lead plate, which will be described in detail below with reference to FIG. 3. The potential difference detection unit 50 includes a first potential difference detector 51 and a second potential difference detector 52 and detects three potential differences between two points based on three different points: a P point, a Q point, and an R point on the positive-side lead plate 41. Each of the first and second potential difference detectors 51 and 52 is preferably composed of a known potential difference detection element formed of a semiconductor chip.

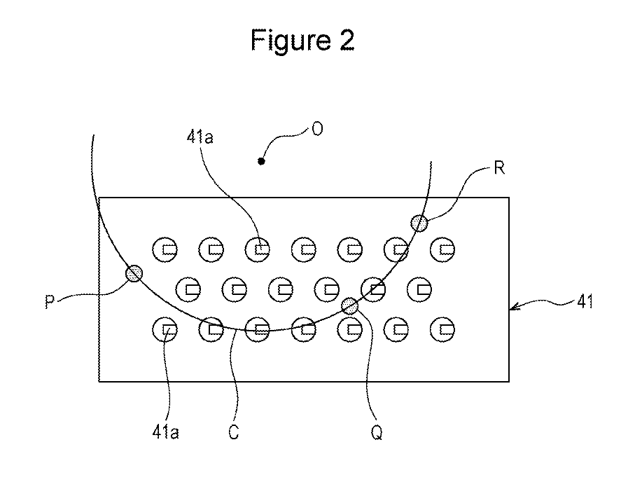

As illustrated in FIG. 2, that is, in a diagram illustrating the positional relationship between the P point, the Q point, and the R point and the positive-side lead plate 41, a center O of a circle C through the P point, the Q point, and the R point is positioned outside the positive-side lead plate 41. On the circle C, the distance between the Q point sandwiched between the P point and the R point and the P point at one end is different from the distance between the Q point and the R point at the other end.

Referring back to FIG. 1, the first potential difference detector 51 detects a potential difference V1 between the P point and the Q point and the second potential difference detector 52 detects a potential difference V2 between the P point and the R point. The potential difference between the Q point and the R point is calculated by subtracting the potential difference V1 detected by the first potential difference detector 51 from the potential difference V2 detected by the second potential difference detector 52. Accordingly, the potential difference detectors 51 and 52 detect the three potential differences between two points of the three points P, Q, and R on the positive-side lead plate 41. When it is assumed that M denotes a natural number greater than or equal to two, all the potential differences between two point of an M-number points on the lead plate are capable of being detected by the potential difference detection units of an (M−1)-number. In the example illustrated in FIG. 1, the three potential differences between two points of the three points P, Q, and R on the positive-side lead plate 41 are detected by the two potential difference detectors 51 and 52.

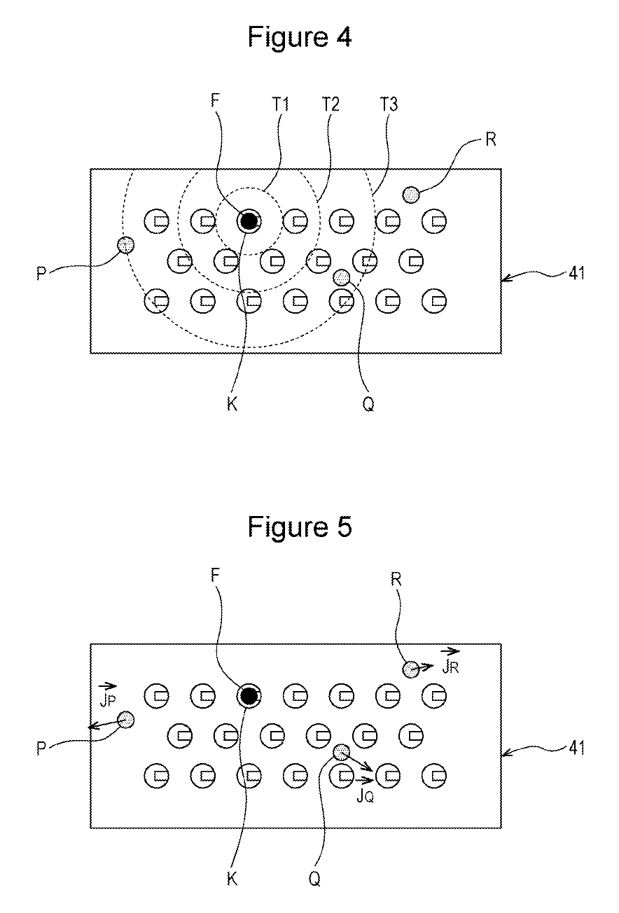

Signals indicating the potential differences from the first and second potential difference detectors 51 and 52 are supplied to the microcomputer 70. The microcomputer 70 calculates the position of any abnormal cell and a supplied or received current value of current which the cell supplies to the positive-side lead plate 41 or which the cell receives from the positive-side lead plate 41 based on the signals indicating the potential differences, which are supplied from the first and second potential difference detectors 51 and 52, and furthermore compares the supplied or received current value with a current threshold value. If the microcomputer 70 determines that the supplied or received current value exceeds the current threshold value, the microcomputer 70 supplies power to an alarm by supplying a signal to a switching element in the alarm power supply circuit 80 to cause the alarm to generate an alarm sound. In addition, if the microcomputer 70 determines that the supplied or received current value exceeds the current threshold value, the microcomputer 70 disconnects the charging circuit 90 by supplying a signal to a switching element in the charging circuit 90 to disable the charging circuit 90 to perform charging. The method of identifying any abnormal cell and calculating the supplied or received current value of current which the cell supplies to the positive-side lead plate 41 or which the cell receives from the positive-side lead plate 41 in the microcomputer 70 will be described in detail with reference to FIG. 4 and the subsequent drawings.

A current value that is lower than a fuse current value at which disconnection of a positive-side fuse 41a that electrically connects each positive electrode, which is one-side electrode, to the positive-side lead plate 41 is supposed or a current value that is lower than a charge and discharge permitted current value that is permitted in the charge and discharge of the cell is preferably adopted as the current threshold value. However, the fuse current value or the charge and discharge permitted current value may be adopted as the current threshold value. The positive-side fuse 41a will now be briefly described. Multiple apertures 41b are provided in the positive-side lead plate 41. The positive-side fuse 41a is a projection unit that projects from each aperture 41b on the positive-side lead plate 41. The positive-side fuse 41a is in contact with the positive electrode of each cell.

An exemplary structure of the module main body 10 will now be described with reference to FIG. 3, that is, an exploded perspective view of the module main body 10.

As illustrated in FIG. 3, the module main body 10 includes multiple cylindrical cells 11 and a cell holder 20 including multiple cylindrical housing units in which the respective cylindrical cells 11 are housed.

Each cylindrical cell 11 includes a cell case 12 made of metal and a power generation element housed in the cell case 12. An electrode body having, for example, a winding structure and non-aqueous electrolyte are included in the power generation element. The cell case 12 is composed of a case body 13 in which the power generation element is housed and which has a cylindrical shape with a bottom and a sealing body 14 with which an opening of the case body 13 is sealed. A gasket (not illustrated) is provided between the case body 13 and the sealing body 14. The sealing body 14 has a layered structure including, for example, a valve body and a cap and functions as a positive terminal of the cylindrical cell 11. In the cylindrical cell 11, the case body 13 functions as a negative terminal. When electrical insulation of the cylindrical cell 11 from the cell holder 20 is required, the outer side face of the case body 13 is covered with an insulating resin film and the bottom face of the case body 13 functions as the negative terminal. Each cylindrical cell 1 is housed in a hole 21 of the corresponding cylindrical housing unit of the cell holder 20.

The module main body 10 includes a pair of posts 30 to be mounted to the cell holder 20. The respective posts 30 are plate members covering both side faces in the lateral direction of the cell holder 20. Each post 30 has a protrusion 31 on one-side face. The respective posts 30 are disposed such that the protrusions 31 are directed to the cell holder 20 side. The respective posts 30 are disposed so as to be opposed to each other with the cell holder 20 disposed therebetween. The protrusion 31 is fitted into the corresponding recess 25 of the cell holder 20.

The positive-side lead plate 41 described above is provided on the cell holder 20 in a state: in which the positive-side lead plate 41 is electrically connected to the respective positive terminals of the multiple cylindrical. cells 11. A positive-side collector plate 40 is provided on the positive-side lead plate 41 in a state in which the positive-side collector plate 40 is electrically connected to the positive-side lead plate 41.

In contrast, a negative-side lead plate 46 is provided below the cell holder 20 in a state in which the negative-side lead plate 46 is electrically connected to the respective negative terminals of the multiple cylindrical cells 11. A negative-side collector plate 45 is provided below the negative-side lead plate 46 in a state in which the negative-side collector plate 45 is electrically connected to the negative-side lead plate 46. The multiple cylindrical cells 11 are connected in parallel to each other with the positive-side and negative-side lead plates 41 and 46. The positive-side lead plate 41 is electrically connected to the positive electrode of each cylindrical cell 11 with the positive-side fuse 41a disposed therebetween, and the negative-side lead plate 46 is electrically connected to the negative electrode of each cylindrical cell 11 with a negative-side fuse 46a disposed therebetween.

An insulating plate 42 having apertures formed therein, from which the respective terminal portions of the multiple cylindrical cells 11 are exposed, is provided between the cell holder 20 and the positive-side lead plate 41. An insulating plate 47 having apertures formed therein, from which the respective terminal portions of the multiple cylindrical cells 11 are exposed, is provided between the cell holder 20 and the negative-side lead plate 46. The positive-side collector plate 40, the negative-side collector plate 45, and so on are fixed to the pair of posts 30 using, for example, screws not illustrated. The module main body 10 is connected in series to another module main body 10 that is adjacently disposed using, for example, the positive-side collector plate 40 and the negative-side collector plate 45.

The principle and method of identifying any abnormal cell 11 in the battery module 1 and calculating the supplied or received current value of current which the cell 11 supplies to the positive-side lead plate 41 or which the cell 11 receives from the positive-side lead plate 41 by the microcomputer 70 will now be described.

The positive-side lead plate 41 has resistance. If any cell 11 the resistance of which is greatly different from those of the other cells 11 occurs, among the cells 11 connected in parallel to each other, cross current occurs between the multiple cells 11 in an open circuit state in which the charging and the discharging are not performed or during the charging and discharging and the cross current flows through the positive-side lead plate 41. As a result, the potential difference caused by the flow of the cross current occurs in the positive-side lead plate 41.

Specifically, if any abnormal cell 11 the resistance of which is abnormally higher than those of the other cells II occurs, the voltage of the abnormal cell 11 when the charging is terminated is made lower than those of the other cells 11 because it is difficult to charge the abnormal cell 11 during the charging. As a result, all the cells 11 attempts to average the voltages in the open circuit state after the charging is terminated and the charging and discharging occur between the cells 11. Specifically, only the abnormal cell 11 is rapidly charged while the normal cells 11 discharge and large current flows from the normal cells 11 into the abnormal cell 11 through the positive-side lead plate 41. The battery module 1 detects the potential difference occurring in the positive-side lead plate 41, which is caused by the current that flows into the abnormal cell 11, to identify the abnormal cell 11 the resistance of which is abnormally higher than those of the other cells 11 in the open circuit state.

In contrast, if any cell 11 the resistance of which is abnormally lower than those of the other cells 11 occurs, for example, because of an occurrence of short-circuit in the cell 11, abnormally large current flows into the abnormal cell 11, compared with the current flowing into the other cells 11, during the charging. In addition, if any cell 11 the resistance of which is abnormally lower than those of the other cells 11 occurs, abnormally large current flows from the abnormal cell 11, compared with the current flowing from the other cells 11, during the discharging. As a result, the flow of the current occurring in the positive-side lead plate 41 is varied from the flow of the current occurring in the positive-side lead plate 41 during the charging and discharging in normal cases, and the potential difference occurring in the positive-side lead plate 41 is varied from the potential difference occurring in the positive-side lead plate 41 during the charging and discharging in the normal cases. The battery module 1 detects the varied difference to identify the abnormal cell 11 the resistance value of which is abnormally lower than those of the other cells 11 during the charging and discharging.

FIG. 4 is a diagram illustrating the distribution of the potential difference occurring in the positive-side lead plate 41 when any abnormal cell (the abnormal cell is hereinafter referred to as a cell K) occurs.

A case is exemplified in which current is released from the cell K. In this case, the potential from a portion F where the cell K exists is decreased with the increasing distance from the cell K. Specifically, T1 [V], T2 [V], T3 [V] represent equipotential lines in FIG. 4. Each of the equipotential lines T1, T2, and T3 composes a concentric circle centered at F. In this example, the distance from F to T1, the distance from F to T2, and the distance from F to T3 are sequentially increased in this order. Accordingly, the relationship of T1>T2>T3 is met.

The resistances from the cell K to the measurement points P, Q, and R are increased as the distances from the cell K to the measurement points are increased. As a result, the values of current flowing from the cell K to the measurement points P, Q, and R are decreased. In this embodiment, since the distance from F to Q, the distance from F to P, and the distance from F to R are sequentially increased in this order, the value of the current flowing from the cell K to Q, the value of the current flowing from the cell K to P, and the value of the current flowing from the cell K to R are sequentially decreased in this order.

A method of calculating the position of the cell K and the supplied or received current value which the cell K supplies or which the cell K receives in the present embodiment will now be described with reference to FIG. 5. FIG. 5 is a diagram illustrating current flowing through the positive-side lead plate 41, which forms a two-dimensional plane, using two-dimensional vectors.

Referring to FIG. 5, since three distances between two points of the respective points P, Q, and R are known and the resistance [Q/m] of the positive-side lead plate 41 is also known, the resistances of the three distances between two points are known. In addition, the three potential differences between two points are also known from measurement. Accordingly, two components on the positive-side lead plate 41 of a two-dimensional vector JPQ of current flowing from the point P to the point Q are calculated (identified) from the relationship of Vector V=Vector I×R [Q]. Two components on the positive-side lead plate 41 of a two-dimensional vector JQR of current flowing from the point Q to the point R and two components on the positive-side lead plate 41 of a two-dimensional vector JRP of current flowing from point R to the point P are calculated (identified) in the same manner.

When the two-dimensional vectors of current flowing from the cell K to the points P, Q, and R are denoted by a vector JP, a vector JQ, and a vector JR, the two components of each of the vectors JP, JQ, and JR are unknown and the sum of six unknowns exist. However, the relationships of Vector JPQ=Vector JQ−Vector JP, Vector JQR=Vector JR−Vector JQ, Vector JRP=Vector JP−Vector JR are established. Accordingly, the sum of six equations are derived from the three relational expressions established between the two-dimensional vectors and the six unknowns are capable of being calculated. Examples of the vectors calculated at the points P, Q, and R by solving the three relational expressions described above are illustrated in FIG. 5.

Accordingly, since the vectors JP, JQ, and JR are calculated, the position of the cell K and the supplied or received current value which the cell K supplies or which the cell K receives are calculated based on the vectors JP, JQ, and JR. The microcomputer 70 calculates the position of one cell 11 having the maximum supplied or received current and the supplied or received current value of current which the one cell 11 supplies or which the one cell 11 receives using the above calculation method. In addition, the microcomputer 70 compares the supplied or received current value with the current threshold value to determine whether the one cell 11 is the abnormal cell K.

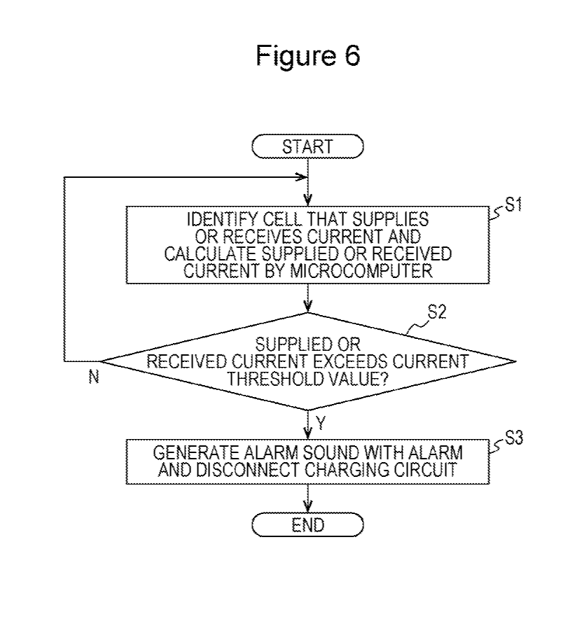

An example of control to determine an abnormality of the battery module 1 by the microcomputer 70 will now be described with reference to FIG. 6. FIG. 6 is a flowchart illustrating an exemplary process of determining an abnormality of the battery module 1, which is performed by the microcomputer 70.

The control is started upon manufacturing of the battery module 1. Upon start of the control, in Step S1, the microcomputer 70 calculates the position of one cell 11 having the maximum supplied or received current and the supplied or received current value of current which the one cell 11 supplies or which the one cell 11 receives based on the signals indicating the potential differences, which are supplied from the first and second potential difference detectors 51 and 52. Then, the process goes to Step S2. In Step S2, the microcomputer 70 determines whether the supplied or received current value of current which the one cell 11 supplies or which the one cell 11 receives exceeds the current threshold value. If the determination in Step S2 is negative, the process goes back to Step S1 to repeat Step S1.

If the determination in Step S2 is affirmative, in Step S3, the microcomputer 70 supplies power to an alarm by supplying a signal to the switching element in the alarm power supply circuit 80 to cause the alarm to generate an alarm sound. In addition, the microcomputer 70 disconnects the charging circuit 90 by supplying a signal to the switching element in the charging circuit 90 to disable the charging circuit 90 to perform the charging. Then, the control is terminated.

According to the above embodiment, the microcomputer 70 constantly calculates the position of one cell 11 having the maximum supplied or received current and the supplied or received current value which the one cell 11 supplies or which the one cell 11 receives based on the signals from the potential difference detectors 51 and 52. Accordingly, unlike the battery module in PTL 1, which is capable of detecting only the cell that is electrochemically disabled, it is possible to detect an abnormality of the cell 11 before the deterioration of the cell 11 advances and the cell 11 is in an electrochemically inactive state. In addition, unlike the battery module in PTL 1, which includes a detection unit that detects an abnormality of each cell, the potential difference detectors 51 and 52 are installed in the module main body 10 including the multiple cells 11 that are connected in parallel to each other. Accordingly, it is possible to reduce the size of the battery module 1 capable of detecting an abnormality.

In addition, the potential difference detectors 51 and 52 identify the three potential differences between two points based on the three different points P, Q, and R on the positive-side lead plate 41. The center O of the circle C through the three points P, Q, and R is positioned outside the positive-side lead plate 41 and, on the circle C, the distance between the point Q sandwiched between the two points and the point P at one end is different from the distance between the point Q and the point R at the other end. Accordingly, regardless of any cell 11 that is selected, the three distances from the cell 11 (the positive-side fuse 41a) to the three points P, Q, and R do not include the same distance.

Furthermore, when the three points P, Q, and R are positioned on a straight line, the distance between the point Q sandwiched between the two points and the point P at one end is different from the distance between the point Q and the point R at the other end. Accordingly, as in the above case, regardless of any cell 11 that is selected, the three distances from the cell 11 (the positive-side fuse 41a) to the three points P, Q, and R do not include the same distance.

As a result, a case does not occur in which the abnormal cell K exists and the three potential differences between two points include the potential difference of zero, and it is possible to calculate the position of the abnormal cell K and the supplied or received current value of current which the cell K supplies or which the cell K receives.

Furthermore, if the microcomputer 70 determines that the supplied or received current value of any cell 11 exceeds the current threshold value, the microcomputer 70 causes the alarm to generate an alarm sound and disconnects the charging circuit. Accordingly, a user is capable of recognizing the abnormal state of the battery module and the safety is capable of being ensured.

The present disclosure is not limited to the above embodiments and modifications of the embodiments and various changes and modifications may be made within the matters described in the claims of the present application and within a range equivalent to the matters.

For example, in the above embodiment, the microcomputer 70, which is the abnormality determination unit, calculates the position of any abnormal cell K and the supplied or received current value of current which the cell K supplies or which the cell K receives based on the three potential differences between two points of the three different points P, Q, and R on the positive-side lead plate 41.

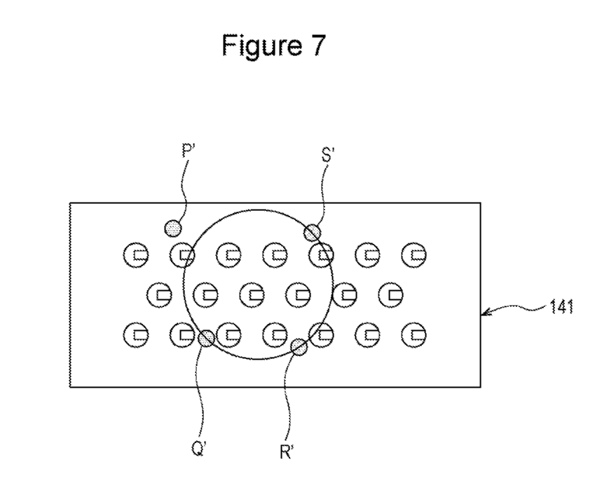

However, the abnormality determination unit may calculate the position of any abnormal cell K and the supplied or received current value of current which the cell K supplies or which the cell K receives based on four potential differences between two points of four different points on the positive-side lead plate. In this case, as illustrated in FIG. 7, that is, in a diagram of a modification corresponding to FIG. 2, if a condition of four points P′, Q′, R′, and S′, which are not positioned on the same circle on a positive-side lead plate 141, is met, one abnormal cell K and the supplied or received current value of current which the cell K supplies or which the cell K receives are capable of being calculated.

Alternatively, the abnormality determination unit may calculate the position of one or more abnormal cells K and the supplied or received current value of current which each of the one or more cells K supplies or which each of the one or more cells K receives based on five or more potential differences between two points of five or more different points on the positive-side lead plate. For example, in a battery module having a large capacity, in which the number of cells that are connected in parallel to each other is 100 or more, the area of the positive-side lead plate is increased. Accordingly, with the three potential difference between two points of the three points, the position of one abnormal cell and the supplied or received current value of current which the one cell supplies or which the one cell receives may not be accurately calculated. In such a case, detection of five or more potential differences between two points enables the accurate detection. Alternatively, in the battery module having such a large capacity, two or more cells may be abnormal. In such a case, detection of five or more potential differences between two points enables the positions of two or more abnormal cells K and the supplied or received current value of current which each of the two or more abnormal cells supplies or which each of the two or more abnormal cells receives to be calculated.

Alternatively, the abnormality determination unit may estimate any abnormal cell K and the supplied or received current value of current which the cell K supplies or which the cell K receives based on one potential difference between two points of two different points on the positive-side lead plate. In this case, it is necessary to select the two different points so that the cell (the fuse) is not positioned at the center of the two points. In addition, in this case, the current threshold value used to determine an abnormality is capable of being determined from, for example, the resistance between two points identified from the positions of the two points and the resistance value [Q/m] of the positive-side lead plate and the charge and discharge permitted current value (a charge and discharge enabled current value) of the cell.

For example, if the abnormal cell K occurs anywhere and current having the charge and discharge permitted current value is supplied or received, a minimum current value I MIN that is supposed to occur between the two points is calculated from the potential difference detected between the two points. Then, the abnormality of any cell may be determined based on whether I OBS actually flowing between the two points exceeds I MIN. Alternatively, in addition to the minimum current value I MIN, a maximum current value I MAX that is supposed to occur between the two points may be calculated and the abnormality of any cell may be determined based on whether I OBS exceeds (I MAX+I MIN)/2. When a denotes a real number that is greater than one, the abnormality or any cell may be determined based on whether I OBS exceeds a×I MIN.

In the above embodiment, if the microcomputer 70, which is the abnormality determination unit, determines that the supplied or received current value of any cell 11 exceeds the current threshold value, the abnormality determination unit performs control to make a notification indicating an abnormal state and control to inhibit the charging. However, when N denotes any natural number, if the abnormality determination unit determines that the number of times when the identified or estimated supplied or received current value goes below the current threshold value after exceeding the current threshold value reaches N, the abnormality determination unit may perform the control to make a notification indicating the abnormal state and the control to inhibit the charging.

The phenomenon in which the identified or estimated supplied or received current value goes below the current threshold value after exceeding the current threshold value occurs in a case in which no current flows through the abnormal cell because the fuse of the abnormal cell blows or a safety device in the abnormal cell works and the battery module returns to a normal state using the remaining cells. When a large number of cells are connected in parallel to each other and the battery module has a large capacity, power that meets a usage condition may be supplied even if one or two cells are disabled.

For example, since the contribution of one cell to power is about 2% when the number of cells that are connected in parallel to each other is 50, there are cases in which it is supposed that power supply is not greatly affected even if one cell fails. In such a case, a notification indicating that the battery module is in the abnormal state may be made in a state in which it is determined that two or more cells fail to disable the charging. In this case, the fuse current value at which disconnection of the positive-side fuse is supposed is preferably adopted as the current threshold value.

The case is described in the above embodiments and modifications in which the microcomputer 70, which is the abnormality determination unit, performs both the control to make a notification indicating the abnormal state and the control to inhibit the charging. However, the abnormality determination unit may perform only one of the control to make a notification indicating the abnormal state and the control to inhibit the charging.

Alternatively, the abnormality determination unit may perform control to display the position of any abnormal cell and the supplied or received current value of the abnormal cell on a monitor by itself or with other control. In the case of the battery module having a large number of cells that are connected in parallel to each other, there are cases in which the abnormal cell is desirably replaced with another one to continue the use of the battery module. Since the position of the abnormal cell is displayed on the monitor in this modification, the abnormal cell is capable of being easily replaced with another one.

### Industrial Applicability

The present invention is available for the battery module.

### REFERENCE SIGNS LIST

1 battery module
41, 141 positive-side lead plate
50 potential difference detection unit
51 first potential difference detector
52 second potential difference defector
70 microcomputer
P, Q, R three different points
C circle through three points
O center of circle through three points
P′, Q′, R′, S′ four points

1. A battery module comprising:
a plurality of cells that are connected in parallel to each other;
a one-side lead plate electrically connected to a one-side electrode of each cell;
a potential difference detection unit that detects three or more potential differences between two points based on at least three different points on the one-side lead plate; and
an abnormality determination unit that determines an abnormality of the cells based on the potential differences between two points from the potential difference detection unit,
wherein the at least three different points are not positioned on the same straight line,
wherein a center of a circle through the at least three different points is positioned outside the one-side lead plate and a distance between one point sandwiched between two points among the at least three different points and a point at one side of the two points is different from a distance between the one point and a point at the other side of the two points on the circle, and
wherein the abnormality determination unit calculates a position of one abnormal cell, among the cells, and a supplied or received current value of current which the one cell supplies or which the one cell receives based on the potential differences between two points.

2. A battery module comprising:
a plurality of cells that are connected in parallel to each other;
a one-side lead plate electrically connected to a one-side electrode of each cell;
a potential difference detection unit that detects three or more potential differences between two points based on at least three different points on the one-side lead plate; and
an abnormality determination unit that determines an abnormality of the cells based on the potential differences between two points from the potential difference detection unit,
wherein the at least three different points are positioned on the same straight line,
wherein a distance between one point sandwiched between two points among the at least three different points and a point at one side of the two points is different from a distance between the one point and a point at the other side of the two points on the straight line, and
wherein the abnormality determination unit calculates a position of one abnormal cell, among the cells, and a supplied or received current value of current which the one cell supplies or which the one cell receives based on the potential differences between two points.

3. A battery module comprising:
a plurality of cells that are connected in parallel to each other;
a one-side lead plate electrically connected to a one-side electrode of each cell;
a potential difference detection unit that detects one or more potential differences between two points on the one-side lead plate; and
an abnormality determination unit that determines an abnormality of one or more of the cells based on the one or more potential differences between two points from the potential difference detection unit,
wherein the potential difference detection unit is capable of detecting four or more potential differences between two points based on at least four different points on the one-side lead plate, and
wherein at least one point among the at least four different points are not positioned on the same circle.

4. The battery module according to claim 1,
wherein, if the abnormality determination unit determines that a supplied or received current value of current which any of the cells supplies or which any of the cells receives, the supplied or received current value being identified or estimated based on a signal indicating the potential differences between two points, exceeds a current threshold value, the abnormality determination unit determines an abnormality of the cell.

5. The battery module according to claim 2,
wherein, if the abnormality determination unit determines that a supplied or received current value of current which any of the cells supplies or which any of the cells receives, the supplied or received current value being identified or estimated based on a signal indicating the potential differences between two points, exceeds a current threshold value, the abnormality determination unit determines an abnormality of the cell.

6. The battery module according to claim 3,
wherein, if the abnormality determination unit determines that a supplied or received current value of current which any of the cells supplies or which any of the cells receives, the supplied or received current value being identified or estimated based on a signal indicating the potential differences between two points, exceeds a current threshold value, the abnormality determination unit determines an abnormality of the cell.

7. The battery module according to claim 4,
wherein, when N denotes any natural number, if the abnormality determination unit determines that a number of times when the identified or estimated supplied or received current value goes below the current threshold value after exceeding the current threshold value reaches N, the abnormality determination unit performs at least one of control to make a notification indicating an abnormal state and control to inhibit charging.

8. The battery module according to claim 5,
wherein, when N denotes any natural number, if the abnormality determination unit determines that a number of times when the identified or estimated supplied or received current value goes below the current threshold value after exceeding the current threshold value reaches N, the abnormality determination unit performs at least one of control to make a notification indicating an abnormal state and control to inhibit charging.

9. The battery module according to claim 6,
wherein, when N denotes any natural number, if the abnormality determination unit determines that a number of times when the identified or estimated supplied or received current value goes below the current threshold value after exceeding the current threshold value reaches N, the abnormality determination unit performs at least one of control to make a notification indicating an abnormal state and control to inhibit charging.

10. The battery module according to claim 4,
wherein the current threshold value is a current value that is lower than a fuse current value at which disconnection of a one-side fuse that electrically connects the one-side electrode to the one-side lead plate is supposed or a current value that is lower than a charge and discharge permitted current value that is permitted in charge and discharge.

11. The battery module according to claim 5,
wherein the current threshold value is a current value that is lower than a fuse current value at which disconnection of a one-side fuse that electrically connects the one-side electrode to the one-side lead plate is supposed or a current value that is lower than a charge and discharge permitted current value that is permitted in charge and discharge.

12. The battery module according to claim 6,
wherein the current threshold value is a current value that is lower than a fuse current value at which disconnection of a one-side fuse that electrically connects the one-side electrode to the one-side lead plate is supposed or a current value that is lower than a charge and discharge permitted current value that is permitted in charge and discharge.

13. The battery module according to claim 7,
wherein the current threshold value is a current value that is lower than a fuse current value at which disconnection of a one-side fuse that electrically connects the one-side electrode to the one-side lead plate is supposed or a current value that is lower than a charge and discharge permitted current value that is permitted in charge and discharge.

14. The battery module according to claim 8,
wherein the current threshold value is a current value that is lower than a fuse current value at which disconnection of a one-side fuse that electrically connects the one-side electrode to the one-side lead plate is supposed or a current value that is lower than a charge and discharge permitted current value that is permitted in charge and discharge.

15. The battery module according to claim 9,
wherein the current threshold value is a current value that is lower than a fuse current value at which disconnection of a one-side fuse that electrically connects the one-side electrode to the one-side lead plate is supposed or a current value that is lower than a charge and discharge permitted current value that is permitted in charge and discharge.
